(19) United States
(12) Patent Application Publication
(10) Pub. No.: US 2003/0061103 A1
(43) Pub. Date: Mar. 27, 2003

(54) Handy terminal with programmable vibration and application software therefor

(75) Inventor: Kazuo Kanai, Itami-shi (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/096,854

(22) Filed: Mar. 14, 2002

(30) Foreign Application Priority Data
Sep. 21, 2001 (JP) 2001-289238

(51) Int. Cl. G06F 17/60

(52) U.S. Cl. 705/22

(57) ABSTRACT

A handy terminal comprises reading unit, a vibration unit, an acoustic unit and a control unit, wherein an application software is installed into the control unit and the control unit is provided with means for controlling the vibration unit or means for controlling the acoustic unit available from the application software. The application software may be provided with a plurality of vibration patterns or a plurality of acoustic patterns and the control unit controls the vibration unit or the acoustic unit according to one of the plurality of vibration patterns or the plurality of acoustic patterns.

### FIELD OF THE INVENTION

The present invention relates to a handy terminal used for stocktaking or inspection of goods in stores or factories.

### BACKGROUND OF THE INVENTION

A schematic view of a general handy terminal is illustrated in FIG. 1. As illustrated in FIG. 1, the handy terminal 10 comprises a display unit 12, input keys 14 and an optical reading unit 20. The input keys 14 are used for receiving input from a user and the optical reading unit 20 is used for reading symbols such as barcodes. The display unit 12 displays instructions from the user or information that is based on read barcodes. It should be noted that the optical reading unit 20 might alternatively be a reading unit employing another method such as a reading unit utilizing magnetic force or a reading unit of contact type utilizing projections or grooves formed on surfaces of objects.

The handy terminal 10 further comprises a control unit in its interior. In case reading is instructed by the user upon pressing any key of the input keys 14, the control unit detects such a key operation by the user to actuate the optical reading unit 20 for reading a barcode. A number or a name of an article corresponding to the read barcode is stored inside the handy terminal 10 as data while also being displayed on the display unit 12. It can be understood from a display screen of the display unit 12 that reading has been successfully completed.

However, it is troublesome for a user to confirm completion of reading upon confirming the display screen each time when reading is performed, and it is especially not preferable in case the number of articles to be handled is large which may lead to loss of time and fatigue of the user. In view of this fact, an acoustic unit such as a speaker or a buzzer was provided within a handy terminal such that operation of the terminal such as completion of reading of a barcode or failure in reading were transmitted to the user as a sign, or signal through such acoustic unit.

However, signs from acoustic unit are often buried in ambient noises especially in crowded stores or noisy factories so that they are hardly heard. In addition, acoustics signs are not at all effective in case the user is hearing-impaired. Thus, a handy terminal provided with functions of transmitting signs through vibration, in addition to sounds generated through speakers or buzzers, is being suggested.

A handy terminal provided with functions of transmitting signs through vibration comprises a vibration unit in addition to the above-mentioned display unit, input keys, optical reading unit and acoustic unit as hardware. Software for governing actions of the hardware is installed within a control unit provided in its interior.

For providing functions that suit purposes of the user, many handy terminals are arranged in that a software package specialized on the purposes needs to be purchased or created by the user him/herself for installation prior to use. Thus, an operating system (OS) for the handy terminal is preliminarily installed within the control unit while a space for installing software provided by the user (hereinafter referred to as “application software”) is additionally prepared.

Actions of the vibration unit within such a handy terminal will be explained with reference to FIGS. 6 and 7. In the flowchart of FIG. 6, the left column represents actions of the application software, the central column represents actions of the operating system (OS), and the right column represents actions of the hardware, respectively.

When the user operates the input keys for instructing reading of a barcode, the operating system detects the key operation and instructs the reading unit to read the barcode (Step S101). The reading unit reads the barcode, and the read data are passed to the operating software (Step S102).

The operating software receives the read data (Step S103), and thereafter, controls the vibration unit or the acoustic unit to generate a sign indicating that reading has been performed (Step S104). The vibration unit or the acoustic unit actuates for informing the user through vibration or sound that reading has been successfully performed (Step S105).

The operating system (OS) further sends the read data to the application software (Step S106). The application software receives the transmitted read data (Step S107) for utilizing them for processes such as counting up or checking with data on hand (Step S108).

In this manner, signs to inform completion of reading, that is, generation of vibration is entirely conducted under the control of the operating software (OS) in a conventional handy terminal (reference should be made to the above-described Step S104). In other words, both means 108 for instructing a sign through vibration and means 106 for controlling the vibration unit to generate the sign are included in the operating system 102 as shown in a block diagram of FIG. 7.

Thus, generation of signs through vibration or sounds are limited to occasions where the hardware 100 of the handy terminal acts, e.g. where the handy terminal is turned ON/OFF, reading by the reading unit is completed or failed, and batteries of the terminal is exhausted. Accordingly, since the timings of the vibration or sound are strictly associated with the hardware actions, the user could not freely set such timings by using the application software 104. The user could not freely set patterns of vibration or sound, that is, their amplitude, frequency or duration, either.

Meanwhile, there are some known handy terminals that offer user's choice in which activation of the vibration unit or acoustic unit and patterns of vibrations or sounds are selectable. However, it should be noted that such handy terminals are similarly arranged in that the means 108 for instructing vibration is included in the operating system 102 as illustrated in FIG. 8. Thus, the user was allowed to merely select one of a plurality of vibration patterns stored within a vibration pattern table 110 through means 112 for selecting vibration patterns offered by the operating system 102 so that vibrations or sounds of desired patterns could not be generated at desired timings.

### SUMMARY OF THE INVENTION

Therefore, an object of the present invention is to provide a handy terminal that is capable of generating signs through vibration or sound at desired timings. A further object of the present invention is to provide a handy terminal that is capable of generating vibration or sound of desired patterns.

In order to attain the above objects, a handy terminal according to the present invention comprises reading unit, a vibration unit, an acoustic unit and a control unit, and is characterized in that an application software is installed into the control unit and the control unit is provided with means for controlling the vibration unit or means for controlling the acoustic unit available for the application software.

Further, a handy terminal according to the present invention comprises a reading unit, a vibration unit, a control unit and an application software installed into the control unit, and is characterized in that the application software is provided with a plurality of vibration patterns and the control unit controls the vibration unit according to one of the plurality of vibration patterns.

Moreover, a handy terminal according to the present invention comprises a reading unit, an acoustic unit, a control unit and an application software installed into the control unit, and is characterized in that the application software is provided with a plurality of acoustic patterns and the control unit controls the acoustic unit according to one of the plurality of acoustic patterns.

Furthermore, a handy terminal according to the present invention comprises a reading unit, a vibration unit, an acoustic unit, a control unit and an application software installed into the control unit, and is characterized in that the application software is provided with a plurality of vibration patterns and a plurality of acoustic patterns, and the control unit controls the vibration unit and the accoustic unit according to one of the plurality of vibration patterns and the plurality of accoustic patterns.

Further, an application software for a handy terminal according to the present invention is characterized in that the handy terminal comprises a reading unit, a vibration unit and a control unit, and the application software is provided with a plurality of vibration patterns so as to actuate the vibration unit with one of the plurality of vibration patterns.

Moreover, an application software for a handy terminal according to the present invention is characterized in that the handy terminal comprises a reading unit, an acoustic unit and a control unit, and the application software is provided with a plurality of acoustic patterns so as to actuate the acoustic unit with one of the plurality of acoustic patterns.

Furthermore, an application software for a handy terminal according to the present invention is characterized in that the handy terminal comprises a reading unit, a vibration unit, an acoustic unit and a control unit, and the application software is provided with a plurality of vibration patterns and a plurality of acoustic patterns so as to actuate the vibration unit and the acoustic unit with one of the plurality of vibration patterns and the plurality of acoustic patterns.

Since the handy terminal of the present invention is capable of controlling timings for generating vibrations or sounds or patterns of such vibrations or sounds through the application software, it is possible to generate vibrations or sounds of desired patterns at desired timings.

These and other objects, advantages and features of the present invention will become more apparent from the following description and the accompanying drawings.

### BRIEF DESCRIPTION OF THE DRAWINGS

FIG. 1 shows a schematic view of a handy terminal;

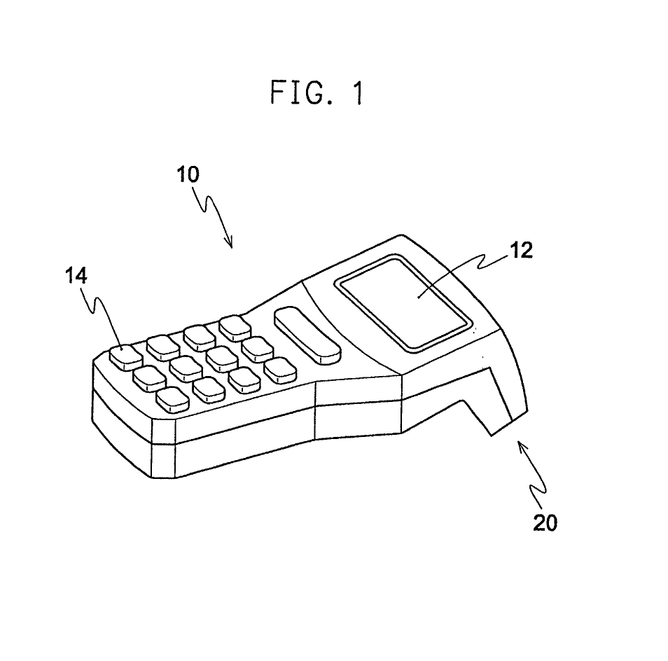

FIG. 2 is a block diagram showing a handy terminal according to the present invention;

FIG. 3 is a schematic block diagram showing a handy terminal according to the present invention;

FIG. 4 is a flow chart showing operation of a handy terminal according to the present invention;

FIG. 5 is a flow chart showing operation of a handy terminal according to the present invention;

FIG. 6 is a flow chart showing operation of a conventional handy terminal;

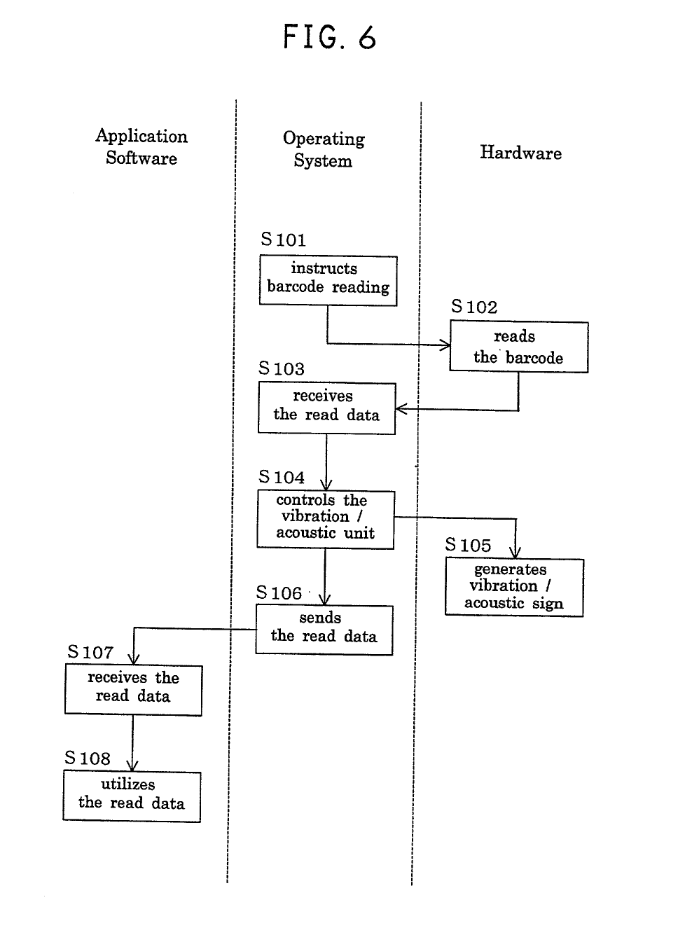

FIG. 7 is a schematic block diagram showing a conventional handy terminal;

FIG. 8 is a schematic block diagram showing a conventional handy terminal.

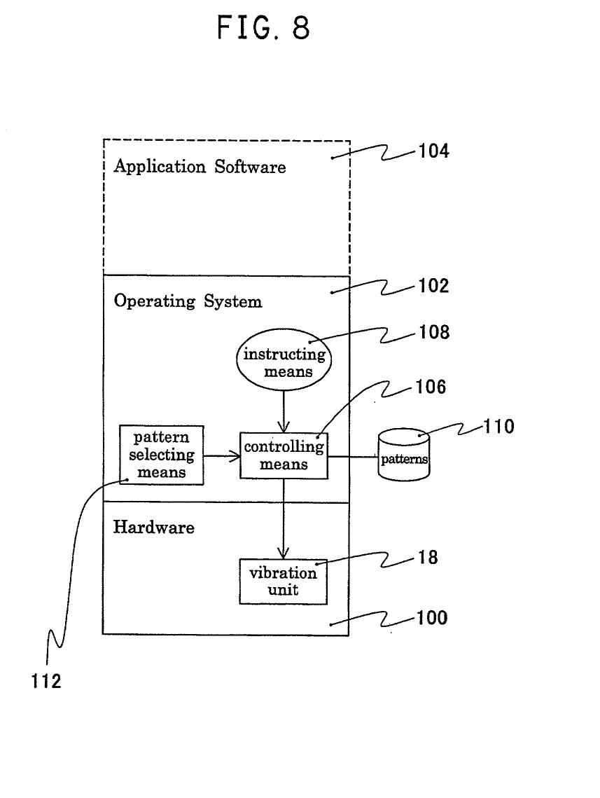

### DETAILED DESCRIPTION

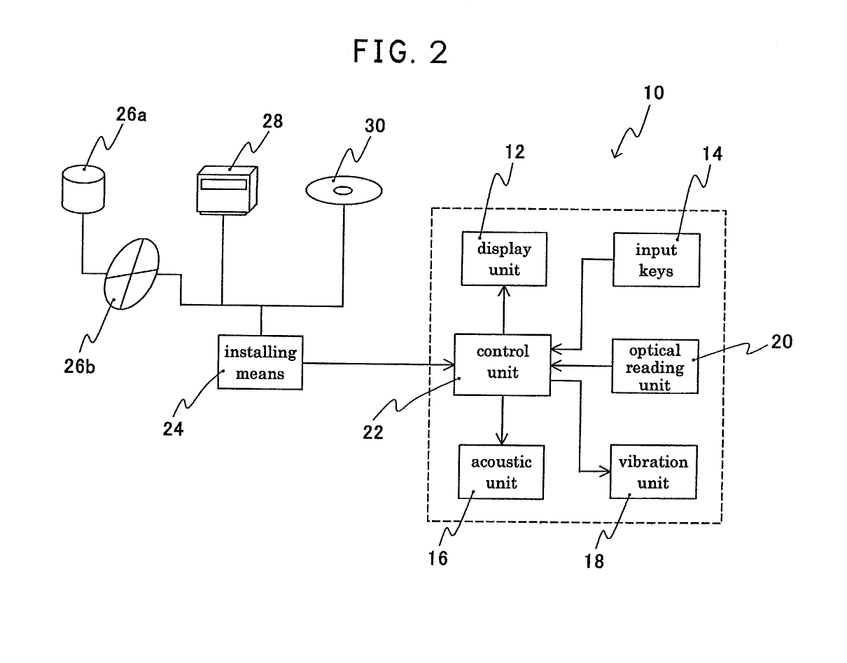

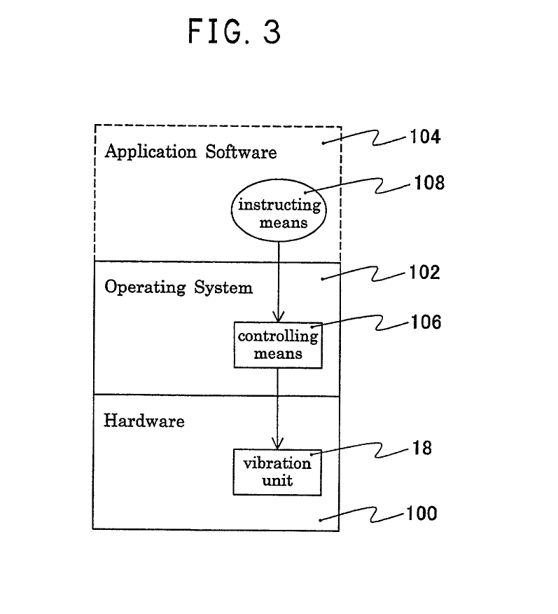

An embodiment of the present invention will now be explained with references to FIGS. 2 and 3.

As illustrated in FIG. 2, the handy terminal 10 of the present embodiment comprises, as hardware, a display unit 12, input keys 14, an acoustic unit 16, a vibration unit 18, and an optical reading unit 20. An operating system (OS) for controlling actions of the hardware is installed into a control unit 22.

Any additional application software that suits purposes of the user may be installed into the control unit 22. The application software may be provided from a server 26a through a network 26b, provided through a recording medium 30 such as a CD-ROM or a flexible disk, or provided as a cartridge 28 that is inserted into the handy terminal 10, and is installed into the control unit 22 by a software installing means 24.

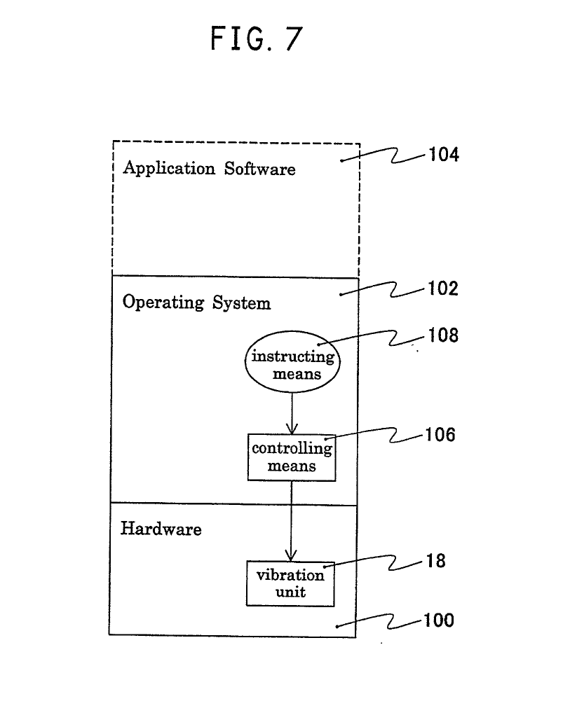

Unlike the conventional handy terminal as shown in the block diagram of FIG. 7, the handy terminal of the present embodiment as shown in FIG. 3 is characterized in that means 108 for instructing vibration is provided in the application software 104.

This can be realized without burdening a developer of the application software, namely the user, when the manufacturer of the handy terminal provides the operating software 102 with an API (application program interface) for utilizing the vibration unit. The developer of the application software shall design the application software to utilize the API when signs through vibration are required.

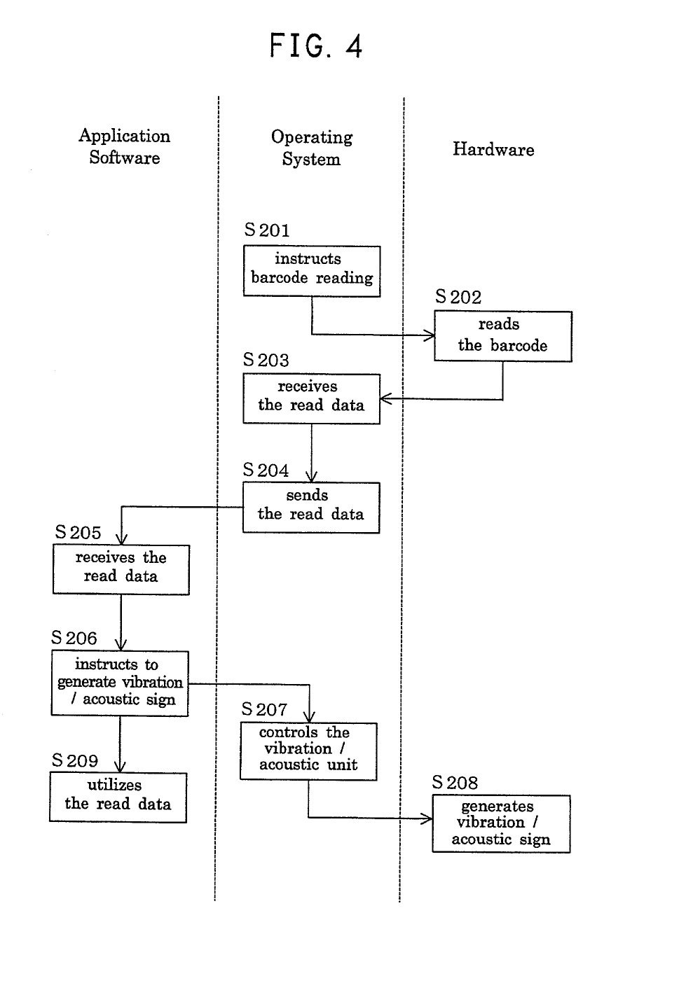

Actions of the handy terminal according to the present embodiment will now be explained with reference to FIG. 4. Also in the flowchart of FIG. 4, the left column represents actions of the application software, the central column represents actions of the operating system (OS), and the right column represents actions of the hardware.

When the user operates the input keys for instructing reading of a barcode, the operating system detects the key operation and instructs the reading unit to read the barcode (Step S201). The reading unit reads the barcode, and the read data are passed to the operating software (Step S202).

The operating software receives the read data (Step S203) and sends the received read data to the application software (Step S204).

The application software receives the transmitted read data (Step S205) and instructs the operating system to generate a sign of vibration or sound indicating that reading has been performed (Step S206).

The operating system controls and actuates the vibration unit or the acoustic unit (Step S207) so that a sign of vibration or sound is generated and transmitted to the user (Step S208).

Further, the application software utilizes the received read data for processes such as counting up or checking with data on hand (Step S209).

As described above and as shown in FIG. 3, the handy terminal of the present embodiment is arranged in that means 108 for instruction to generate a sign of vibration is provided in the application software 104 and means 106 for controlling the vibration unit 18 is provided in the operating system 102. That is, the application software instructs the sign to generate and the operating software controls the vibration unit to generate the instructed sign. Thus, another useful actions as follows may be performed in addition to generation of read signs as described with reference to FIG. 4.

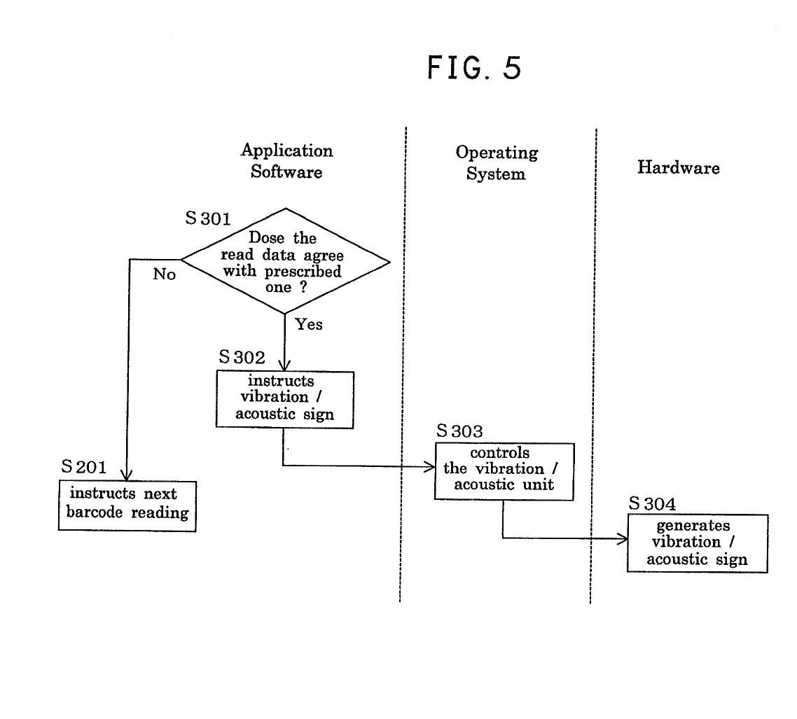

An example of Step S209 of FIG. 4, that is, an example of a utilization of the read data is illustrated in FIG. 5. The application software determines whether the read data as received in Step S205 of FIG. 4 are identical to preliminarily prescribed data (Step S301). In case the data coincide, the application software instructs the operating system to generate a sign through vibration or sound indicating that they are coincident (Step S302). The operating software accordingly controls and actuates the vibration unit or the acoustic unit (Step S303) to generate the sign so that the user is informed by the sign of vibration or sounds that the data are coincident (Step S304).

In case the application software for performing the actions of FIG. 5 is installed into a handy terminal employed, for instance, for goods inspection, it can be transmitted to the user through vibration or sound that goods that have arrived are the correct ones. It should be noted that the application software may be designed to have a plurality of vibration patterns or a plurality of acoustic patterns and to instruct vibration or sounds of specific pattern for each various cases. For example, when the vibration pattern or the acoustic pattern for the case where the data are coincident is varied from that for the case where reading of barcode is completed, operations of the handy terminal are correctly informed to the user through vibrations or sounds so that misunderstanding as well as fatigue of the user are greatly reduced.

As is evident from the above, since the handy terminal of the present invention controls timings for generating vibrations or sounds and patterns of such vibrations or sounds by the application software, it is possible to generate vibrations or sounds also for processes such as comparison of data, checking up of data or counting up of goods in which the operating system (OS) is not involved. Thus, various conditions in which, for instance, read data did or did not coincide with specific data, a kind of data has been read for prescribed times, or a kind of data has reached to certain percentage among the all data, can be transmitted to the user through vibrations or sounds having respective patterns for each conditions.

As explained so far, since the handy terminal of the present invention is capable of controlling timings for generating vibrations or sounds or patterns of such vibrations or sounds through the application software, it is possible to generate vibrations or sounds of desired patterns at desired timings, and various conditions can be transmitted to the user through vibrations or sounds.

While embodiment of the present invention have been described, such descriptions are for illustrative purposes only, and it is to be understood that changes and variations may be made without departing from the sprit or scope of the present invention.

What is claimed is:

1. A handy terminal comprising a reading unit, a vibration unit, an acoustic unit and a control unit;
wherein the handy terminal is used upon installing an application software into the control unit, and the control unit is provided with means for controlling the vibration unit or means for controlling the acoustic unit available for the application software.

2. A handy terminal comprising a reading unit, a vibration unit, an acoustic unit, a control unit and an application software installed into the control unit;
wherein the application software is provided with any one of a plurality of vibration patterns and a plurality of acoustic patterns, and
wherein the control unit controls any one of the vibration unit and the acoustic unit according to any one of the plurality of vibration patterns and the plurality of acoustic patterns.

3. A handy terminal comprising a reading unit, a vibration unit, an acoustic unit, a control unit and an application software installed into the control unit;
wherein the application software is provided with both a plurality of vibration patterns and a plurality of acoustic patterns, and
wherein the control unit controls the vibration unit and the acoustic unit according to one of the plurality of vibration patterns and the plurality of acoustic patterns.

4. An application software for a handy terminal,
wherein the handy terminal comprises a reading unit, a vibration unit, an acoustic unit and a control unit, and
wherein the application software is provided with any one of a plurality of vibration patterns and a plurality of acoustic patterns so as to actuate any one of the vibration unit and the acoustic unit with any one of the plurality of vibration patterns and the plurality of acoustic patterns.

5. An application software for a handy terminal,
wherein the handy terminal comprises a reading unit, a vibration unit, an acoustic unit and a control unit, and
wherein the application software is provided with a plurality of vibration patterns and a plurality of acoustic patterns so as to actuate the vibration unit and the acoustic unit with one of the plurality of vibration patterns and the plurality of acoustic patterns.
